(19) United States
(12) Patent Application Publication
(10) Pub. No.: US 2025/0234858 A1
(43) Pub. Date: Jul. 24, 2025

(54) SYSTEMS AND METHODS FOR CRYOPRESERVATION OF BIOLOGICAL MATERIAL

(71) Applicant: ASYMPTOTE Ltd, Cambridgeshire (GB)

(72) Inventors: Stephen Lamb, Cambridgeshire (GB); Peter Kilbride, Cambridgeshire (GB); Devina Divekar, Cambridgeshire (GB); George Morris, Cambridgeshire (GB)

(73) Assignee: ASYMPTOTE Ltd, Cambridgeshire (GB)

(21) Appl. No.: 18/699,914

(22) PCT Filed: Oct. 12, 2022
(86) PCT No.: PCT/EP2022/078421

§ 371 Date: Apr. 10, 2024

(30) Foreign Application Priority Data
Oct. 26, 2021 (GB) 2115365.5

(51) Int. Cl. A01N 1/162; A01N 1/125; A01N 1/144

(52) U.S. Cl. CPC A01N 1/162; A01N 1/125; A01N 1/144

(57) ABSTRACT

Disclosed are systems and methods for the cryopreservation of biological samples. The system including a mixing device configured hold the biological sample and a cryoprotectant and mix the contents therein. The mixing device can include a basket that moves within mixing device to ensure efficient mixing of the cryoprotectant. The system further includes a cooling device to cool the sample and cryoprotectant. The method includes placing a biological sample within the basket, such that the container is subject to cooling by the cooling device. Subsequently, cryoprotectant is added while the cooling device cools the biological sample. During this process the basket is moved within the container.

### TECHNICAL FIELD

The present invention relates to systems and methods for cryopreservation of samples, and in particular to the cryopreservation of biological samples, such as biopsies and tissue samples, using vitrification.

### BACKGROUND

Cryopreservation is a technique used for the preservation of biological samples that involves cooling samples to, and maintaining them for prolonged periods at very low temperatures, for example −80° C., −136° C. or −196° C. By cooling a biological sample to a low temperature, the kinetics of chemical or enzymatic reactions that would otherwise degrade the sample are slowed to such an extent that the sample no longer degrades or only degrades at very slow rate. As a result, biological samples can be stored over prolonged periods and then recovered as required for use and/or analysis.

Cryopreservation can, however, have detrimental effects on a biological sample. Damage to biological samples during cryopreservation processes mainly occurs during the cooling/freezing stage and the warming stage. Solution effects, extracellular ice formation, intracellular ice formation, membrane effects, solute toxicity and dehydration can all lead to sample damage. Some of these effects can be reduced by introducing compounds with known protective impact during the cryopreservation cycle. Compounds with a protective impact during cryopreservation are referred to as cryoprotectants or cryoprotective additives (CPAs), such as dimethylsulphoxide (DMSO).

Additionally, the cryopreservation of biopsies, mature organoids, tissues larger than a few mm3, and ultimately larger biological tissues has long been an aim in diagnostics, transplant medicine and regenerative medicine market where cryopreservation remains the key bottleneck. Biopsies are cryopreserved for many reasons, including diagnostics, cell isolation, and fundamental research. One valuable area is their use for population-wide studies where biopsies are taken from many patients over many years and stored in biobanks. These biobanks can act as a precious resource of tissue taken before a patient shows symptoms of a disease or condition, sometimes years in advance of the symptoms first developing. This can give a huge benefit to early detection of disease, and factors which may influence its development.

For most effective use in diagnostics, preservation methods must allow for tissue morphology to be preserved, DNA and proteins extracted, and for cells to be grown on thaw. The same is true for cancer treatments, where preserving tissue samples can be used in the isolation of immune cells, such as lymphocytes, diagnostics, and greater understanding and treatment of the cancer. However, using current methods either the tissue morphology or living cells can be preserved, but not both.

To preserve morphology, tissues should be cryopreserved in the absence of ice. This is done through a method known as vitrification, where high concentrations of cryoprotectants are used to stop ice forming (over 50% by volume). However, the high concentration of cryoprotectants used are toxic and result in near-complete cell death. Lower concentrations of cryoprotectants can be used (approximately 10%), however ice will form in these systems disrupting the tissue morphology. To avoid doubt, any mention of vitrification throughout the text is meant to be defined as cryopreservation in the absence, or near absence, of ice.

As mentioned above, vitrification is an ice-free cryopreservation technique. Vitrification relies on bringing a sample resident in a vitrification/cryopreservation medium to below the glass transition temperature (Tg) of that vitrification/cryopreservation medium without allowing ice crystals to form, either in the extracellular solution or within the biological material. At temperatures below the glass transition the solvent/medium solidifies to deliver a stable sample in which the biological material resides within a low temperature matrix of amorphous solid vitrification/cryopreservation medium. A number of approaches to cryopreserve through vitrification have been examined, which include:

(A) adding a high concentration of a cryoprotectant (CPA) to a biological sample prior to cooling that reduce the ice nucleation temperature of the medium and aqueous components of the sample and also increase the viscosity of the aqueous components of the sample so that ice crystal formation during cooling below the equilibrium freezing point is avoided and the transition from the liquid to the solid state does not involve crystallisation. Vitrification of biological samples however typically requires rapid cooling, for example cooling rates of 10,000° C./min or more and this intrinsically limits the approach to very small sample sizes. Typically, vitrification samples are presented in a straw with an internal diameter of 1 mm or less, and is now the standard method of cryopreservation of oocytes and embryos for IVF applications. For larger samples it is very difficult to utilize such a technique.

(B) Vitrification may also be achieved with a combination of rapid cooling and simultaneous application of high pressure, but this involves high cost and requires skilled operators. This approach is also limited to sample preparation for high resolution electron microscopy.

(C) An alternative approach, particularly targeted at organs for transplantation employs slow cooling of the sample with the addition of cryoprotectant during cooling to avoid ice formation. The composition of the solution is controlled to follow the liquidus curve of the phase diagram of the solution employed. This technique has been demonstrated to be effective for small pieces of muscle, with manual addition of the cryoprotectant during cooling. However, attempts at scaling up or automating the process, despite extensive research have all failed.

As the above discussion highlights, cryopreservation is critical for cell therapies. Storing cells, tissues, and biopsies at low (non-frozen) temperatures does not preserve the cells for long enough. The fraction of cells that survive the freeze/thaw process can be low and variable, which has a financial impact on the treatment as more cells must be grown upstream to compensate the loss during freezing and thawing. Therefore, there is a need for systems and methods which ensure a higher and more consistent rate of cell survival while also maintains tissue/biopsy structure, resulting in significant technical and commercial benefits.

One system that attempted to address the above shortcomings is the Liquidus Tracker system developed by Planer. However, this system lacked adequate mixing means, required a complex fluid management system, and is not suitable as a long-term storage system.

Therefore, it is an object of the present invention to provide improved cryopreservation systems and methods that are suitable for the preservation of biological samples, in particular tissues, biopsies, and organs that is not subject to the disadvantages of known equilibrium cryopreservation and vitrification techniques and provides improved and more consistent cell survival and tissue/biopsy structure.

### SUMMARY OF INVENTION

The present invention, in one aspect, relates to a system for the cryopreservation of at least one biological sample. The system comprises one or more mixing devices configured to hold the at least one biological sample and a cryoprotectant; and a cooling device configured to cool the one or more mixing devices; wherein the one or more mixing devices each further comprises a basket for receiving the at least one biological sample; and wherein the basket is configured to move within the respective mixing device.

In embodiments, the basket comprises an arm and/or drive shaft connected to a sample receiving area to receive the at least one biological sample, and the arm and/or drive shaft is configured to rotate such that the sample receiving area and the at least one biological sample rotate within the mixing device.

In embodiments, the one or more mixing devices each comprise a container and a cap, wherein the basket is located within the container and the drive shaft extends from the sample receiving area to the cap, and wherein the basket is removeable from the container.

In embodiments, the system further comprises a motor located external to the container, the motor configured to impart a force on the arm and/or drive shaft in order to cause the arm and/or drive shaft to rotate; and a clutch coupled to the motor.

In embodiments, the sample receiving area has a cylindrical shape with a sidewall, and a retaining wall extends across the sample receiving area, creating a sample compartment, the sample compartment being smaller in size than the sample receiving area.

In embodiments, the retaining wall and/or the side wall are at least partially porous.

In embodiments, the basket further comprises a filler located on a first side of the retaining wall within the sample receiving area, and wherein the at least one biological sample is configured to be located on a second side, opposite the first side, of the retaining wall corresponding to the sample compartment.

In embodiments, the basket further comprises at least one arm, the at least one arm connecting the drive shaft to the sample receiving area; and a porous lid configured to cover the sample receiving area.

In embodiments, the system further comprises a processing unit; at least one pump; a temperature sensing means; a support plate, the one or more mixing devices configured to sit in the support plate; and a cryoprotectant reservoir, containing the cryoprotectant connected, to the at least one pump; wherein the temperature sensing means is configured to measure a temperature of the cooling device, the support plate and/or the one or more mixing devices, wherein the processor is configured to receive an output from the temperature sensing means, and wherein processing is configured to (i) control the cooling device to control a rate of cooling based upon a sensed temperature and (ii) control activation of the pump to control addition of the cryoprotectant to the one or more mixing devices based upon a sensed temperature, such that the biological sample is vitrified.

In embodiments, the cooling device is configured to cool the biological sample at a rate of between 0.1-5° C./min, and wherein the basket is configured to rotate at a rate of between 5 and 120 rpm.

The present invention, in another aspect, relates to a method for the cryopreservation of a biological sample. The method comprises: a) placing a biological sample within a basket located in a container; b) placing the container within a support plate; c) adding a cryoprotectant to the container such that the biological sample is exposed to the cryoprotectant; d) cooling the container during step c) with a controlled rate freezer; and e) moving the basket within the container during the cooling in order to mix the cryoprotectant.

In embodiments, step e) comprising rotating the basket within the container.

In embodiments, the cooling is at a rate of about 0.1 to 5.0 C/min.

In embodiments, the basket is rotated at a rate of about 5-120 rpm.

In embodiments, cryoprotectant is added continuously during the cooling. In further embodiments, the cryoprotectant is added in a stepwise manner, such that addition occurs every time the container is cooled by between 1-5° C., more preferable, between 1-2° C.

In embodiments, a temperature sensing means measures a temperature of the container, the support plate, or the controlled rate freezer, and an amount of the cryoprotectant added is controlled based on the measured temperature.

In embodiments, a rate of cooling is controlled based on the measured temperature and a phase diagram of the cryoprotectant.

In embodiments, the cryoprotectant is not removed from the container during the cryopreservation.

In embodiments, the biological sample is vitrified.

The present invention, in a further aspect, relates to a method for warming a cryopreserved biological sample that has undergone the cryopreservation method above. The method comprises removing the basket from the container; and placing the basket, containing the biological sample and cryoprotectant, within a warming solution.

In embodiments, as the biological sample and cryoprotectant warm, the cryoprotectant separates from the basket and the biological sample.

### DRAWINGS

The invention will now be described in more detail with reference to the appended drawings, wherein:

FIG. 1 illustrates a system for cryopreservation of a biological sample;

FIG. 2 illustrates a cooling device, support plate, and container of the system of FIG. 1, according to embodiments of the invention;

FIGS. 3A-B illustrate perspective views of the mixing device of FIGS. 1 and 2, in solid and cross-sectional orientations, respectively, according to embodiments of the invention;

FIG. 4 illustrates an exploded view of the mixing device of FIGS. 1-3B, according to embodiments of the invention;

FIGS. 5A-C illustrate baskets of the mixing device of FIGS. 1-4, according to embodiments of the invention;

FIG. 6 illustrates a basket of the mixing device of FIGS. 1-4, according to further embodiments of the invention;

FIG. 7 illustrates a cross-sectional view of the basket of FIG. 6 loaded into a.

FIG. 8 illustrates a mixing device incorporating the basket of FIG. 6, according to embodiments of the invention.

FIG. 9 illustrates the mixing device of FIG. 8 with a vent port attached.

FIGS. 10A-B illustrate cross-sectional views of the mixing device and associated motor, according to embodiments of the invention.

FIG. 11 illustrates the basket of the mixing device of FIGS. 1-5B undergoing warming, according to embodiments of the invention;

FIG. 12 illustrates a block diagram of a method of cryopreservation utilizing the system of FIG. 1, according to embodiments of the invention;

FIG. 13 illustrates a graph showing sample temperature and CPA addition during cryopreservation of the method of FIG. 12, according to one example of the method of FIG. 12;

FIG. 14 illustrates a block diagram of a method of warming after the cryopreservation of FIG. 12; and

FIG. 15 illustrates graphs showing total recovered cells, cell viability, and viable cell number after carrying out cryopreservation of FIG. 12 and warming and FIG. 14, according to one example.

FIG. 16 illustrates graphs showing cell viability and alarm blue florescence intensity after carrying out cryopreservation of FIG. 12 and warming and FIG. 14, according to a further example.

### DETAILED DESCRIPTION

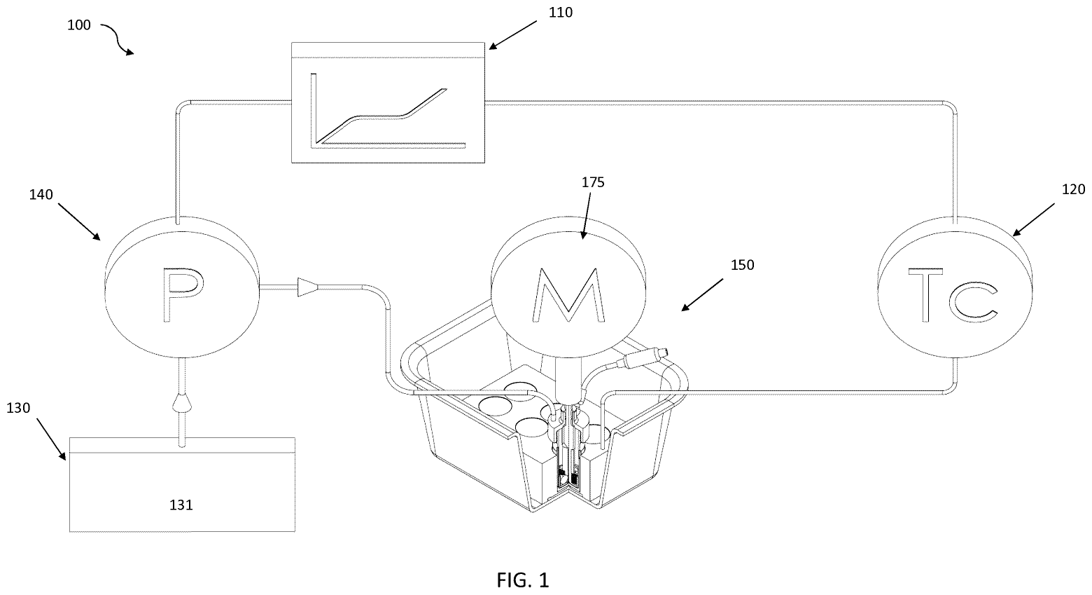

Referring to FIG. 1, and a first aspect of the invention, there is shown a cryopreservation system 100 (herein after referred to as cryopreservation system 100 or system 100). The system 100 includes a processing unit 110, a temperature sensing means 120, a fluid reservoir 130, at least one pump 140, and a mixing and cooling arraignment 150. As will described in greater detail below, the system 100 is configured to cryogenically preserve at least one biological sample 185 (hereafter referred to as “biological sample” or “sample”), and more specifically to vitrify at least one biological sample 185. This is accomplished by placing the at least one biological sample 185 (e.g., a tissue sample, an organ, etc.) within the mixing and cooling arraignment 130. Once therewithin, the system 100 is configured to cool the biological sample 185 while adding a cryoprotectant 131. The biological sample 185 is moved/agitated within the mixing and cooling arraignment 150 during the process such that the cryoprotectant 131 effectively mixes. The effective mixing advantageously allows the system to add high levels of cryoprotectant 131 during the cooling process while minimizing cellular toxicity. By controlling the cooling process in conjunction with the addition of cryoprotectant 131 and mixing, the biological sample is vitrified (i.e., cryopreserved in the absence of ice).

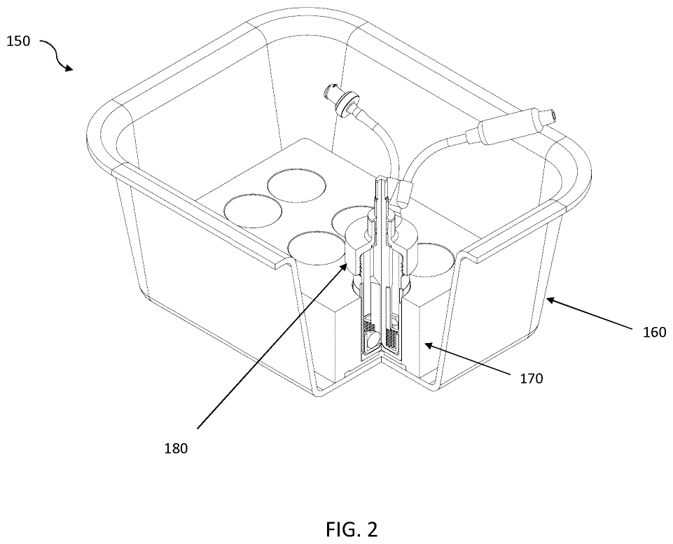

As FIGS. 1 and 2 provide, the mixing and cooling arraignment 150 further includes a cooling device 160 (e.g., a controlled temperature rate change freezer, for example, a commercially available freezer known as Via Freeze™, or any other device which provides a controlled rate change in temperature), a support plate 170, and a mixing device 180. The fluid reservoir 130, which contains a cryoprotectant 131, is in fluid communication with the mixing device 180. The fluid communication can be accomplished via tubes, pipes, or the like. At least one pump 140 is configured to provide a motive force (as illustrated by the arrows) through the fluid communication such that the cryoprotectant 131 can be moved from the fluid reservoir 130 into the mixing device 180. Temperature sensing means 120 is configured to measure a temperature of the cooling device 60, support plate 170, the mixing device 180, and/or the biological sample 185 located within the mixing device 180. As will be described in further detail below, the pump 140 and temperature sensing means 120 are connected, either wirelessly or through suitable wiring, to processing unit 110. While not explicitly shown in the Figures, the cooling device 160 may also be connected to the processing unit 110, or the cooling device 160 can have a separate dedicated processing unit. The processing unit 110 may be configured to control activation of the pump 140, at least in part based upon the sensed temperature. In this way, precise addition of cryoprotectant is accomplished according to the sensed temperature.

Referring to FIG. 2, the cooling device 160 is configured to cool the biological sample 185. This is accomplished by placing the mixing device 180, which houses the biological sample 185, into a support plate 170 that is placed in thermal contact with the cooling device 160. According to the illustrated embodiment, the mixing device 180 has a cross-sectional shape (e.g., circular), and the support plate 170 has at least one complementarily shaped cavity such that the mixing device 180 sits therein. The support plate is made of a material with high thermal conductivity, such as aluminium. As illustrated, the support plate 170 can include a plurality of cavities (e.g., six) for housing a plurality of mixing devices 180. It is to be understood that the number of cavities, and their locations in the support plate 170 is not limited to what is illustrated (e.g., 1, 2, 3, 4, 7 or more cavities can be used, and the cavities can be at any location within the support plate 170 and have differing sizes and shapes). Additionally, the depth of the cavities in support plate 170 is large enough, such that the support plate 170 surrounds a substantial portion of the mixing device 180. In embodiments, the support plate 170 surrounds approximately 50-100% of the mixing device 180. By surround a large portion of the mixing device, accurate and efficient cooling is accomplished. In other words, when the cooling device 160 begins to cool, thermal energy removal is efficiently transferred to a substantial portion of the mixing device 180, via the support plate 170.

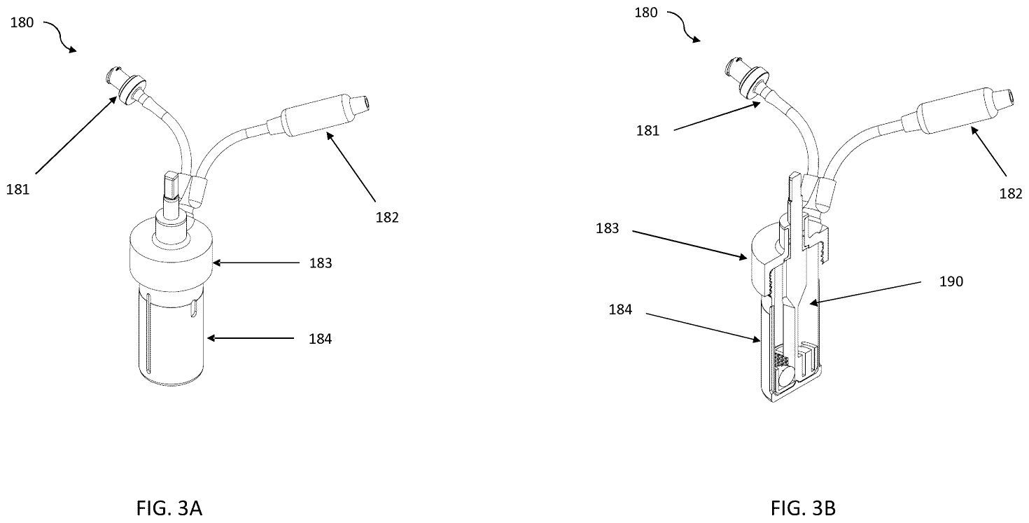

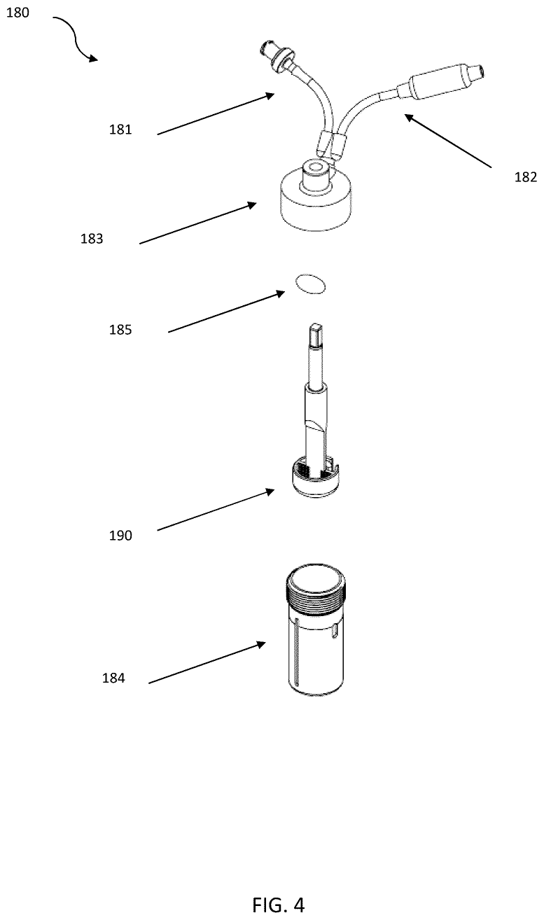

Referring to FIGS. 3A to 4, mixing device 180 includes a container 184, a cap 183 configured to attach to a top of the container 184 (e.g., by press fitting or threaded engagement), and a basket 190. As FIG. 3A provides, the mixing device 180 includes a container 184 having a generally cylindrical shape (e.g., shaped as a vial) with a cavity formed therein. While a cylindrical container 184 is illustrated, container 184 can have other shapes (e.g., have a cross-sectional shape that is ovular, elliptical, square, rectangular. Etc.). Cap 183 is configured to be placed on the top of container 184 in order to seal the cavity. The cap 183 includes two ports in the form of an inlet port 181 and a vent port 182. As will be described in further detail below, the inlet port 181 is connected to the fluid reservoir 130 in order to provide a fluid pathway from the reservoir 130 to the cavity within the container 184, and the vent port 182 is exposed to the atmosphere in order to allow gas to escape from the cavity as cryoprotectant is added. The vent port 182 may include a filter (not shown) to ensure that only gasses escape. The mixing device 180 further includes a basket 190, as illustrated by FIGS. 3B-5B. Basket 190 is configured to be removably placed within the cavity of container 184. As FIG. 4 illustrates, the container 184 is configured to house basket 190 within its cavity, and at least one biological sample 185 is placed within the basket. Cap 183 can then be placed on the container 184, which seals the biological sample 185 with the basket 190 in the container 184.

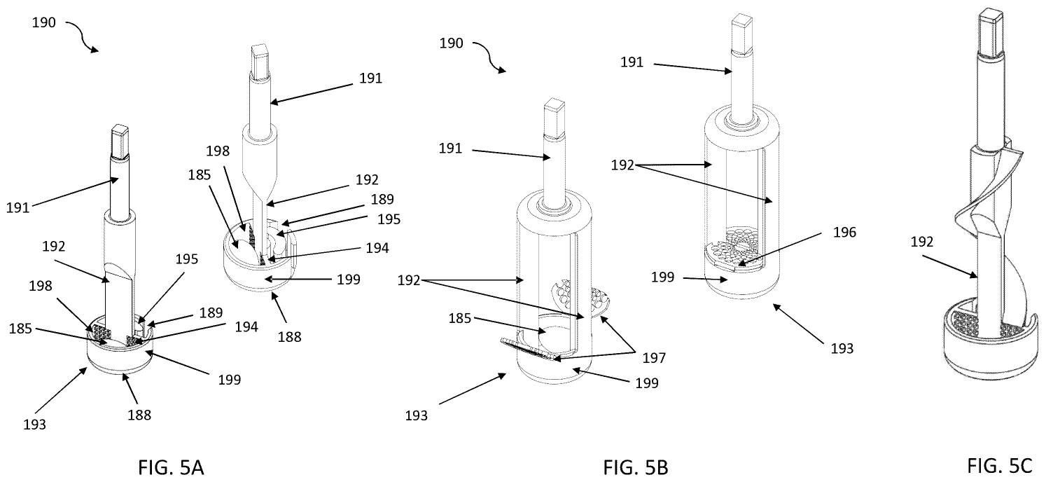

Referring to FIG. 5A, one embodiment of the basket 190 is illustrated. As mentioned above, basket 190 is configured to fit into the cavity of container 184. Basket 190 includes a sample receiving area 193 that the biological sample 185 is configured to sit within. Specifically, the sample receiving area 193 includes a base 188 and side wall 199 forming a generally cylindrical cavity. The cylindrical cavity includes a sample compartment 198 delimited by the side wall 199 and a retaining wall 194. Sample compartment 198 is thus in the form of a generally semi-circular cavity, having a depth corresponding to the height of the sidewall 199.

Extending from the base 188 is an arm 192 connected to, or integrally formed with, a drive shaft 191. In one embodiment, as FIG. 5A provides, the retaining wall 194 is made up of two discrete portions, connected to one another by a bottom portion of arm 192. According to one alternative embodiment, as FIG. 5B illustrates, two (or more) arms 192 are connect to a top of the sidewall 199. In this configuration, the retaining wall 194 may be a single piece that extends across the cylindrical cavity. The arm(s) 192 may be located opposite to one another along the circumference of the sample receiving area 193, and more than one pair of opposing arm(s) 192 can be implemented. However, the arm(s) 192 do not have to be in opposing pairs and an odd number of arm(s) 192 can be implemented in equidistant (or non-equidistant) locations around the circumference of the sample receiving area 193. According to a further embodiment, as FIG. 5C illustrates, the arm 192 can include a helical or spiral-like protuberance along at least a portion of its length.

The biological sample 185 is configured to be placed within the sample compartment 198, as illustrated. A filler 195 may be placed opposite the biological sample 185 (i.e., in the remaining space of sample receiving area 193). Filler 195 is shaped to conform to a portion of the remaining portion of the cylindrical cavity (e.g., may be an arcuate shaped clement) and is configured to reduce the dead volume of sample receiving area, which aids in mixing and allows for a smaller starting volume. Specifically, by reducing the dead volume in the sample receiving area 193 local concentrations of cryoprotectant components are minimized during mixing, and the starting volume necessary to cover the biological sample 183 is minimized. It is noted, however, that completely eliminating the dead volume (e.g., by completely filling remaining space of the cylindrical cavity) is not preferred, as some space should be left in order to allow the cryoprotectant to flow across the retaining wall 194. Such a flow region minimizes the likelihood of stagnant zones, which can cause localized concentrations of CPA components. Additionally, the sidewall 199 may have at least one gap/discontinuity 189 in an area corresponding to the location of filler 195. As described in more detail below, the at least one gap/discontinuity 189 aids in mixing as well as the removal of the cryoprotectant during the thawing process.

The container 184, basket 190, and lid 196 may be made from suitable materials that can sustain cryogenic temperatures. In embodiments, these components can be made from polymers that can withstand temperatures of up to −180° C. For example, the polymer can be selected from polypropylene, polytetrafluoroethylene, and ethylene-vinyl acetate. In further embodiments, the material can be metallic, such as stainless steel.

As mentioned above, it is desirable to allow the cryoprotectant 131 to efficiently mix when added to the container 184. This is at least partially effectuated by having retaining wall 194 be porous. According to one example, retaining wall 194 can have an array of holes therein or be made from a porous material. The pore/hole size should be selected such that the biological sample 185 (and fragments thereof) should not be able to pass therethrough, but also large enough to ensure that the CPA 131 can freely flow into the sample compartment 198. Such a pore size can be approximately 0.1-2 mm in diameter. However, larger and smaller pore sizes are within the scope of the invention. In addition to (or in place of) the porous retaining wall 194, basket 190 can include a porous lid 196 that covers the top of the cylindrical cavity of sample receiving area 193 (see FIG. 5B). The lid 196 can include two lid portions 197 that are configured to open and close in order to allow for insertion and retention of the biological sample 185 in the sample compartment. It is explicitly noted that the retaining wall 194, filler 195, and gap/discontinuity 189 may be implemented in the embodiment of FIG. 5B, although not explicitly illustrated.

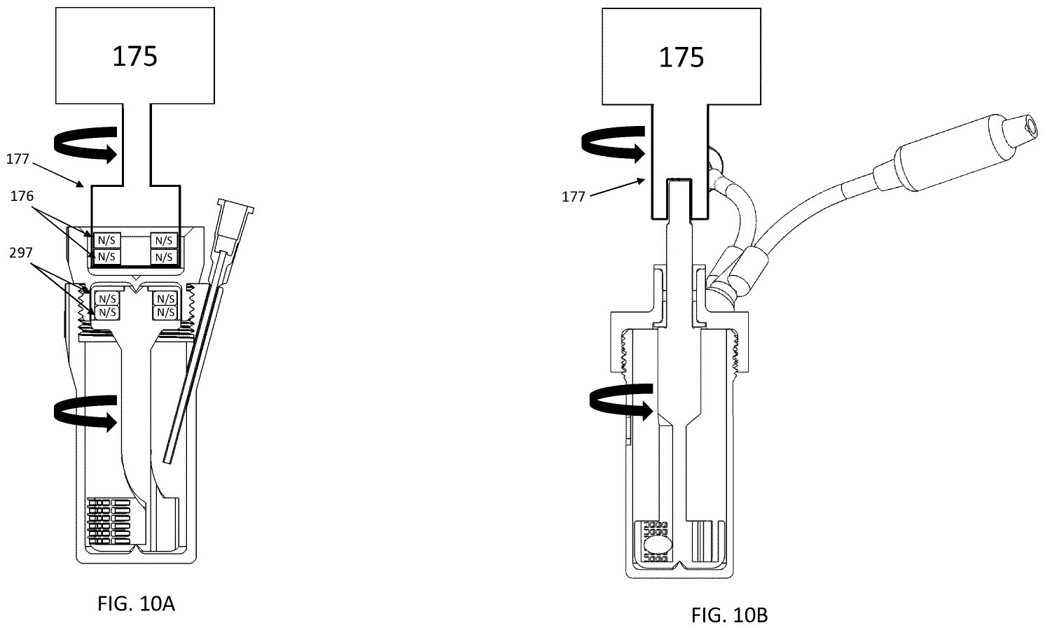

The driveshaft 191, as best illustrated in FIGS. 3A-3B and 10B, extends the length of the container 184 and through an aperture in the lid 196. A fluid tight seal (e.g., O-ring) may be placed in the aperture to ensure that liquid does not escape therethrough. In this way, the driveshaft 191 can be connected to a motor 175 (see, e.g., FIG. 10B). As FIG. 10B illustrates, motor 175 may include a housing 177 that extends and engages with the top end of driveshaft 191. When activated, the motor 175 is configured to provide a motive force sufficient to turn the driveshaft 191, thus causing the basket 190 to rotate (e.g., spin) within the container 184 about a central axis of the driveshaft 191. The central axis of the driveshaft 191 can correspond to a central axis of the container 184. In further embodiments, the central axis of the driveshaft 191 can be offset from the central axis of the container 184 (such that the basket moves in a circular pattern around the periphery of the container 184). Further, the central axis of the driveshaft 191 can be centered on the sample receiving area 193 or offset thereof. In one alternative embodiment, the driveshaft 191 does not extend through the lid 196 but is magnetically coupled to the motor 175. For example, an array of magnets can be located in/on the drive shaft 191, arm(s) 192, or the like, and be magnetically coupled to the motor 175. A stator of the motor can be used to cause rotation of the magnets in the basket 190. By rotating the basket 190, the biological sample 185 is moved within the container in a circular motion. In this way, when cryoprotectant is added to the container 184 mixing is effectuated by rotation of the basket 190.

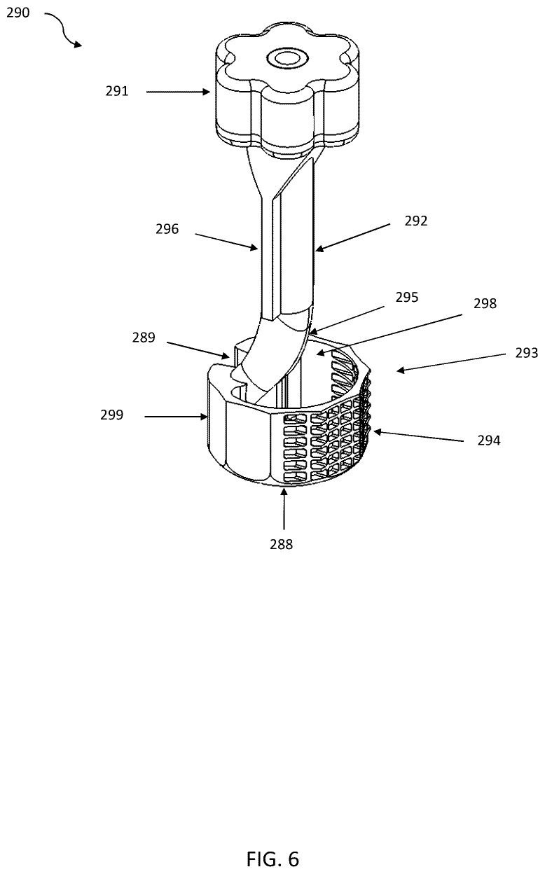

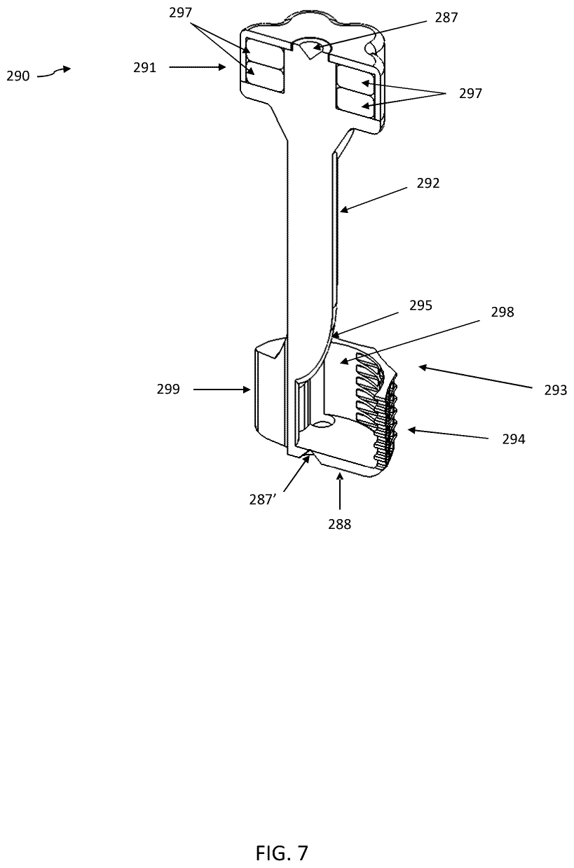

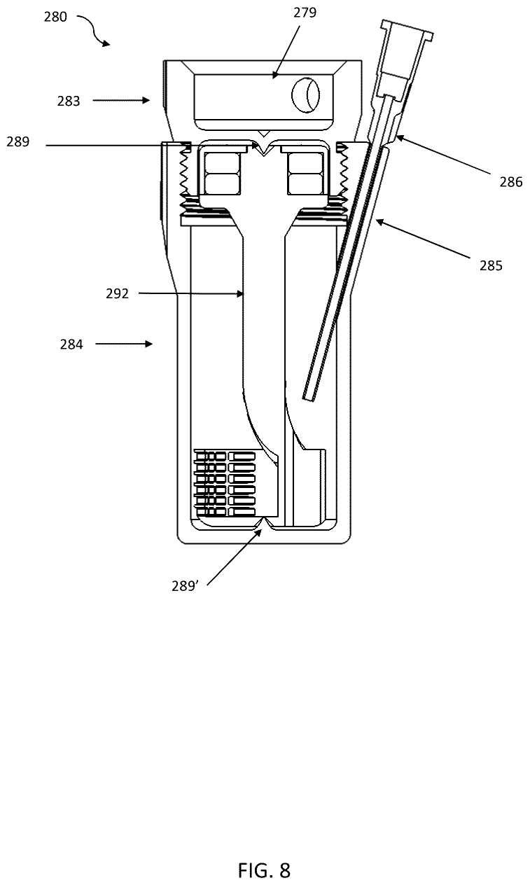

A further embodiment of the invention is illustrated in FIGS. 6-9. Referring to FIGS. 7-9, mixing device 280 includes a container 284, a cap 283 configured to attach to a top of the container 284, and a basket 290. As FIG. 8 provides, the mixing device 280 includes a container 284 having a generally cylindrical shape (e.g., shaped as a vial) with a cavity formed therein. Cap 283 is configured to be placed on the top of container 284 in order to seal the cavity (e.g., by press-fit or threaded engagement).

The container 284 includes two ports in the form of an inlet port 285 and a vent port 281. As will be described in further detail below, the inlet port 285 is connected to the fluid reservoir 130 in order to provide a fluid pathway from the reservoir 130 to the cavity within the container 284, and the vent port 281 is exposed to the atmosphere in order to allow gas to escape from the cavity as cryoprotectant is added. The vent port 281 may include a filter 282 to ensure that only gasses escape. The mixing device 280 further includes a basket 290, as illustrated by FIGS. 6-8. Basket 290 is configured to be removably placed within the cavity of container 284. As FIG. 8 illustrates, the container 284 is configured to house basket 290 within its cavity, and at least one biological sample 185 (not shown) is placed within the basket 290. Cap 283 can then be placed on the container 284, which seals the biological sample with the basket 290 in the container 284.

Referring to FIG. 6, one embodiment of the basket 290 is illustrated. As mentioned above, basket 290 is configured to fit into the cavity of container 284. Basket 290 includes a sample receiving area 293 that the biological sample 185 is configured to sit within. Specifically, the sample receiving area 293 includes a base 288 and side wall 299 forming a generally cylindrical cavity. The cylindrical cavity includes a sample compartment 298 delimited by the side wall 299 and base 288. Sample compartment 298 is thus in the form of a generally circular cavity, having a depth corresponding to the height of the sidewall 299. As will be further described below, a portion of the sidewall 299 includes pores 294. The pores 294 are configured to allow fluid to enter and exit the sample receiving area 293 more easily.

Extending from the sidewall 299 is an arm 292. As shown in FIGS. 6-9, the arm 292 extends from the sidewall 299, and may include a curved portion 295, such that the arm 292 extends along a central longitudinal axis of the basket 290. By having the arm 292 initially located off center, the size of the cavity within the sample receiving area 298 can be maximized. Additionally, the lower section of arm 292 acts as a filler (e.g., carries out the same or similar function to filler 185) by occupying a portion of the sample receiving area 298. The arm 292 may optionally include at least one paddle or fin 296. Alternatively, the arm 292 may include a helical groove or protrusion (see, e.g., FIG. 5C). These features aid in mixing when the basket 290 is rotated within the container 284.

A housing 291 is located at the top of the arm 292. The housing 291 includes an array of magnets 297, as best illustrated by FIG. 7. As will be described in more detail with regard to FIG. 10, at least two magnets are located within housing 291 in a circular pattern. As specifically illustrated by FIGS. 6 and 7, pairs of stacked magnets 297 are located in a circular/hexagonal pattern within housing 291. It should be noted that instead of a pair of magnets at each location one or three or more magnets may be used. Further, the Figures illustrate six pairs of magnets 297, but fewer or more magnets 297 may be implemented. Additionally, adjacent magnets (when viewed along the circular/hexagonal pattern) alternate polarity such that a magnetic motor can drive the arm 292, as will be further described below.

The biological sample 185 is configured to be placed within the sample compartment 298. The sidewall 299 may have at least one gap/discontinuity 289. As described in more detail below, the at least one gap/discontinuity 289 aids in mixing as well as the removal of the cryoprotectant during the thawing process.

The container 284, basket 290, and lid 296 may be made from suitable materials that can sustain cryogenic temperatures. In embodiments, these components can be made from polymers that can withstand temperatures of up to −180° C. For example, the polymer can be selected from polypropylene, polytetrafluoroethylene, and ethylene-vinyl acetate. In further embodiments, the material can be metallic, such as stainless steel.

As mentioned above, it is desirable to allow the cryoprotectant 131 to efficiently mix when added to the container 284. This is at least partially effectuated by having pores 294. According to one example, the pore/hole size should be selected such that the biological sample 285 (and fragments thereof) should not be able to pass therethrough, but also large enough to ensure that the CPA 131 can freely flow into the sample compartment 298. Such a pore size can be approximately 0.1-2 mm in diameter. However, larger and smaller pore sizes are within the scope of the invention

The arm 292, as best illustrated in FIGS. 8-10, extends the length of the container 284 and joins with housing 291. In order to ensure proper alignment of the lid 283, basket 290, and container 283, an array of protrusions and indentations may be implemented. As shown in FIGS. 7-9, the top of housing 291 may include an indentation 287, while the bottom of base 288 may also include an indentation 287′. As FIG. 8 shows, lid 283 and container 284 each include a corresponding protuberance 289, 289′ that are each configured to rest within the indentations 287, 287′. In additional to providing alignment, the protuberance 289, 289′ and indentations 287, 287′ are sized and shaped such that the top and bottom of the basket 290 do not directly abut the lid 283 or container 284, which would otherwise prevent the basket 290 from properly rotating during use.

In order to effectuate rotation of the arm, and thus the basket, a motor 175 (see, e.g., FIG. 10A) is magnetically coupled to the mixing device 280. In one example, motor 175 includes a housing 177 that includes an array of magnets 176 that correspond to the magnets 297 located within housing 291, but with an opposite polarity. As FIG. 10A illustrates, housing 177 includes a portion thereof that extends into a cavity 279 located in the top of lid 283. The magnets 176 are located in a patter to generally match the location of magnets 297 located in housing 291.

When activated, the motor 175 spins magnets 176, which are configured to provide a motive force (i.e., magnetic repulsion) sufficient to turn the 292, thus causing the basket 290 to rotate (e.g., spin) within the container 284 about a central axis of the basket 290. In one specific example, a stator of the motor can be used to cause rotation of the magnets in the basket 290. By rotating the basket 290, the biological sample 185 is moved within the container in a circular motion. In this way, when cryoprotectant is added to the container 284 mixing is effectuated by rotation of the basket 290.

In embodiments, the motor 175 and its associated components (e.g., magnets 176) can be integrated into a lid (not shown). The lid can be sized and shaped to cover the cooling device 160. In such a configuration the lid aids in keeping the system insulated during the cooling and vitrification process. Further, controller 110 (or a separate dedicated controller) can also be integrated into the lid.

Such a mixing mechanism advantageously ensures that the biological sample is not exposed to localized concentrations of components within the cryoprotectant that become toxic at higher concentrations (e.g., DMSO). This means of mixing overcomes shortcomings of prior art system that include a simple stirring element because it has been found that moving the biological sample, as compared to merely mixing the fluid, provides more uniform mixing and exposure of the cryoprotectant to the biological sample. Said another way, prior art systems that include known stirring elements typically cause inefficient mixing since the biological sample is statically located in a bottom of a container. Because the stirring element should not come in direct contact with the biological sample (in order to ensure physical damage to the biological sample is avoided), mixing at the site of the biological sample stagnates. This is exacerbated by the fact that as the container is cooled, the cryoprotectant thickens and increases in viscosity. At higher viscosities it becomes even more difficult to adequately mix the cryoprotectant in prior art systems, thus causing localized concentrations of cryoprotectant components that are toxic to biological materials. However, by causing the biological sample to safely move (e.g., spin) within the container the above drawbacks are avoided.

Additionally, the present invention further improves upon the prior art because arm(s) 192, 292 provide a second means of mixing. As the basket 190, 290 rotates, so does the arm(s) 192, 292. As FIGS. 5A and 6 illustrate, at least a portion of the arm 192, 292 can be flat/planar and can optionally include at least one protuberance 296. By rotating the arm(s) 192, 292, the flat/planar portion and protuberance 296 causes mixing of the cryoprotectant 131. Similarly, as FIG. 5B illustrates, arms 192 can be located along a periphery of the basket 190, or more generally be located a distance from the central axis of rotation and/or driveshaft 191. When the basket 190 rotates, arms 192 also rotate inside the container 184 (e.g., along a circular path corresponding to the circumference of the sidewall 199), further aiding in mixing.

A clutch (not shown) may also be included and connected to the motor 175. For example, if the basket 190, 290 becomes lodged or otherwise stuck within the container 184, 284, or if freezing occurs, the clutch provides a mechanism to ensure that the motor 175 does not continue to turn the driveshaft 191 or arm 292, which would otherwise cause the driveshaft 191 or arm 292 (or other components of the system 100) to break. In other words, by including a clutch, a certain amount of slipping is allowed to occur, thus preventing the motor 175 from damaging the overall system 100 in use.

Additionally, a rotational sensor (e.g., Hall sensor) may be implemented to monitor rotation of the basket 190, 290. By monitoring the rotation of the basket 190, 290 and the motor 175 speed, the system 100 can determine if the basket 190, 290 rotation is being impeded, which can cause the system 100 to stop the motor 175 and/or generate an alter/alarm. Additionally, and/or alternatively, the container 184, 284 can include a viewing window or be made from a transparent material, such that visual inspection of the basket 190, 290 can be carried out.

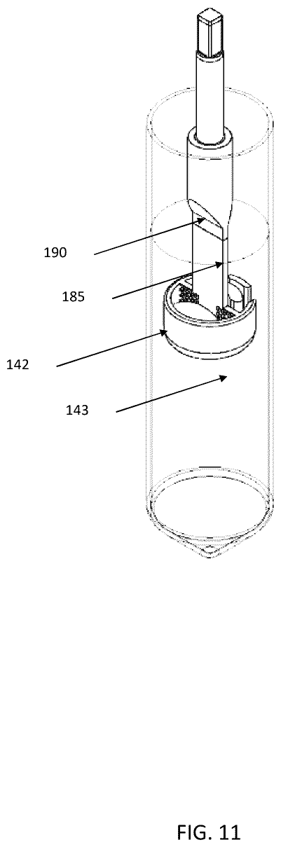

As will be further described below, once the biological sample 185 is cryopreserved (e.g., vitrified), the mixing device 180, 280 can be removed from the system 100 and placed into long-term cold storage. Once there is a need or desire to warm the biological sample 185 it can be removed from the container 184, 284 and warmed. Advantageously, since the basket 190, 290 is easily removable from the container 184, 284, the biological sample 185 can be removed from the container 184, 284 without direct user contact (i.e., removal of the basket 190, 290 effectuates removal of the biological sample 185). The basket 190, 290 can be placed, for example in a vial 142 to undergo warming, as illustrated by FIG. 11. It is explicitly noted that while FIG. 11 illustrates basket 190 of FIGS. 3-5, the basket 290 is configure for use in the same way. The vial 142 can be filled with a warming fluid (e.g., culture media) and the basket 190, 290 can be at least partially submerged therein. When the basket 190, 290 is made from a polymer that is less dense than the fluid (e.g., polypropylene), the basket 190, 290 will float in the vial 142. By floating within the warming fluid, the present invention advantageously aids in the separation of the cryoprotectant from the biological sample 185. In other words, the basket 190, 290 and biological sample 185 float in the vial, and the cryoprotectant that remains in the basket from the cryopreservation process is free to fall out of the basket and settle in the bottom of the vial 142.

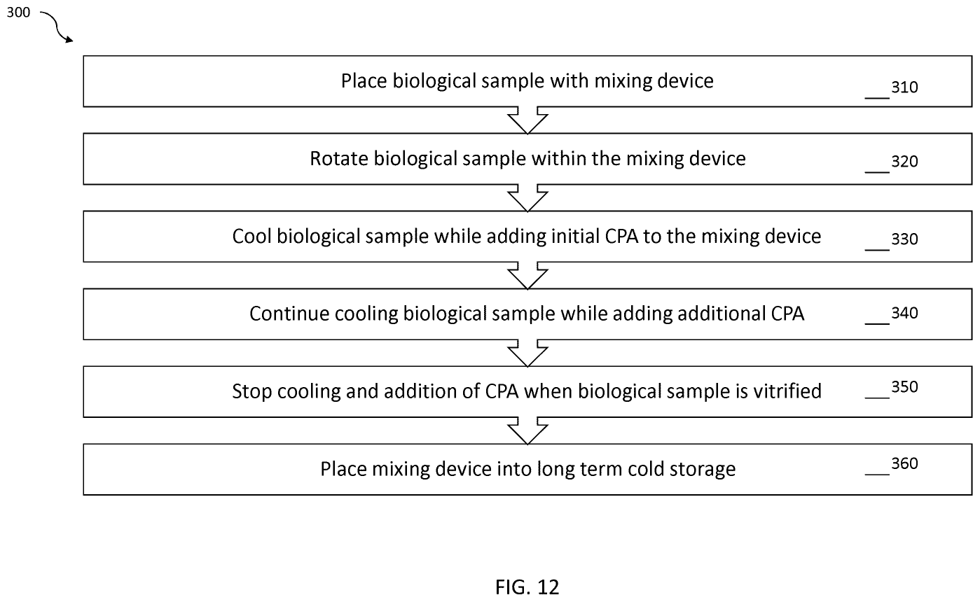

Referring to FIG. 12, and a second aspect of the invention, there is shown a block diagram illustrating a method 300 of cryopreservation utilizing the system 100. As referenced above, at least one biological sample 185 is placed within basket 190, 290 of mixing device 180, 280, corresponding to step 210. The basket is placed within the container 184, 284, an initial volume of culture media is added, and the lid 196, 283 is attached thereto. The mixing device 180, 280 is then placed into support plate 170 located on cooling device 160. It is noted that the setup includes creating a fluid connection between the reservoir 130 and inlet port 181, 285.

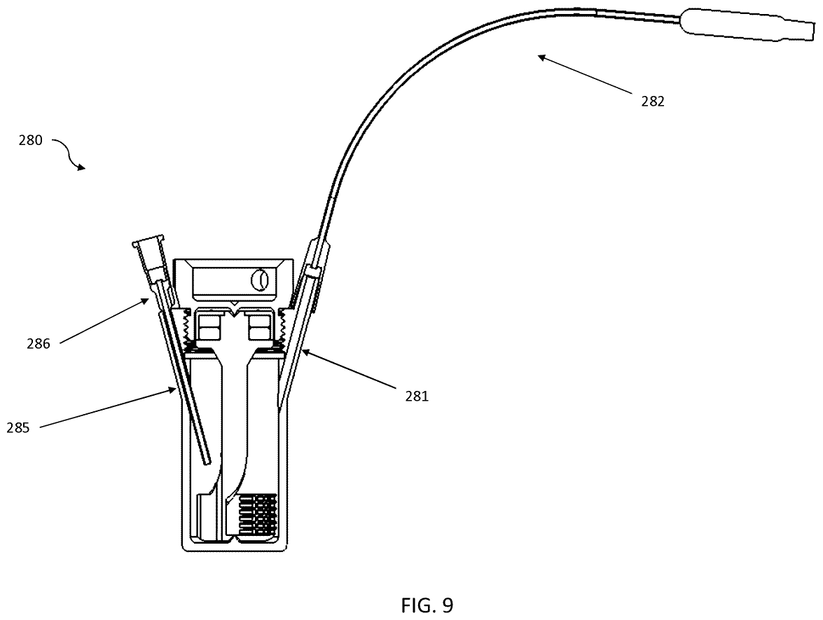

In the embodiment of FIG. 3A, this is effectuated by connecting tubing to the inlet port 181 which is further connected to the reservoir 130. In an alternative embodiment, as illustrated by FIG. 9, container 284 of mixing device 280 may include an integrated inlet port 285 that is angled towards the bottom of container 284. The inlet port is shaped to accommodate a needle 286. As shown, the needle 286 penetrates the container 284, such that the tip of the needle 286 is located near the sample receiving area 298. This helps to ensure that cryoprotectant is added in a highly controlled manner and at a location close to the base of the container 284 and to aiding in the mixing process.

The processing unit 110 is also connected to the at least one pump 140,

temperatures sensing means 120, and optionally the cooling device 160. The motor 175 then begins to rotate the basket 190, 290, corresponding to step 320.

The cooling device 160 then begins to transfer heat out of the system 100 while the temperature sensing means measures the temperature of the support plate 170 (which is meant to approximate the temperature of the biological sample 185). Alternatively, the temperature sensing means measure the temperature of the cooling device 160, and/or the one or more mixing devices 190, 290.

Cooling is carried out from a starting temperature (e.g., ambient temperature) down to approximately 0-4° C. The cooling rate for this can be between approximately 0.1 to 2.0° C./min. Then an initial volume of cryoprotectant (also referred to as CPA) 131 located within the reservoir 130 is pumped, via activation of pump 140, through inlet port 181, 285 into the container 184, 284 such that the cryoprotectant 131 is exposed to the at least one biological sample 185, corresponding to step 330. During the addition, the motor 175 continues to effectuate rotation of the basket 190, 290 and biological sample 185, within the container 184, 284. The basket 190, 290 can be rotated at speeds of approximately 5-120 rpm, which have been found to provide adequate mixing without shearing or damaging the at least one biological sample 185.

The initial volume addition of CPA 131 added to the container 184, 284 should be kept at a minimum, as the final volume of CPA added to the container 184, 284 is approximately 5 times larger. According to preferred embodiments, the starting volume addition of CPA is approximately 1-5 ml, meaning that the final added volume is approximately 5-25 ml. Because a small starting volume ensures that the final volume is not excessive, it is important to reduce dead volume within the sample receiving area, as mentioned above. This is accomplished by the inclusion of filler 195 into the sample receiving area. Specifically, by filling a large portion (but not all) of the space of sample receiving area 193 (excluding the sample compartment 198), the amount of starting volume necessary to cover, or substantially cover, the at least one biological sample 185 is kept at a minimum.

The cooling device 160 continues to cool the system while additional CPA 131 is added to the container 184, 284 and the basket 190, 290 rotates, corresponding to step 340. The rate of cooling and rate of addition of CPA 131 can be controlled by the processing unit 110. In one example, the rate of cooling and addition of CPA can be synchronized based on time. In a further example, cooling is controlled according to a user-defined profile and measured by the temperature sensing means 120, and the CPA is added according to the sensed temperature (or change in temperature) and a phase change diagram. In a still further example, cooling is controlled and measured by the temperature sensing means 120, and the CPA is added according to the sensed temperature (or change in temperature) and a phase change diagram. It is noted that CPA addition can occur continuously or in a stepwise fashion. In specific embodiments where stepwise addition is carried out, the CPA is added such that addition occurs after the container is cooled by between 1-5° C. (e.g., every time a change in temperature of between 1-5° C. is sensed), more preferable, between 1-2° C. (e.g., every time a change in temperature of between 1-2° C. is sensed). Similarly, the basket 190, 290 can be rotated continuously or only when the CPA is being added to the container 184, 284. Step 340 includes addition of CPA (either continuous or stepwise addition) until the final volume is reached. Concurrently, the cooling device 160 cools the system (either continuous or in a stepwise manner) until the biological sample is vitrified, corresponding to step 350. The rotation rate of the basket 190, 290 can be between approximately 5-120 rpm, and the speed can be static or varied during any of the steps. Further, the cooling rate can be between approximately 0.2-5° C., and can be static or varied during any of the steps. Still further, the amount of CPA addition is based upon the size of the biological sample 185 and the initial starting volume necessary to cover the biological sample 185.

It is noted that vitrification is accomplished by controlling the cooling rate and rate of addition of CPA according to a reference phase diagram of the CPA. In other words, step 340 is controlled such that an amount of CPA is added, the amount being that required to prevent ice formation at each temperature (i.e., the CPA is kept in a liquid phase). The reference phase diagram can be acquired from scientific literature or derived from experimental techniques, such as Differential Scanning Calorimetry, which allow the liquidus curves to be established.

Once vitrified, the mixing device 180, 280 can be removed from the support plate 170 and placed directly into long-term storage. One notable advantage of the present system is that vitrification and long-term storage of the biological sample 185 occur within the same vessel (i.e., the mixing device 180). By using the same vessel, transfer to long-term storage becomes simpler and easier than prior art systems and methods.

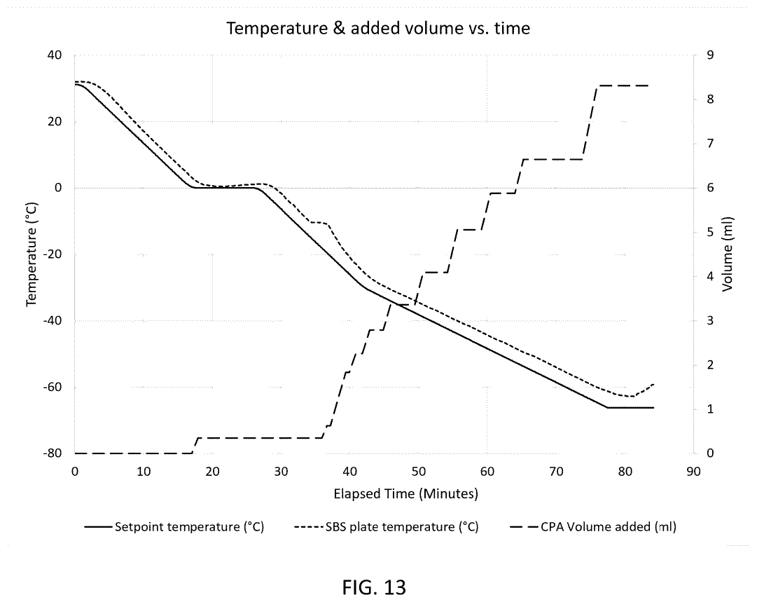

FIG. 13 is a graph illustrating one example of cryopreservation, by carrying out the method 300 of FIG. 12. As shown, the x-axis is time, while the y-axis is temperature (left side) and volume addition of CPA 131 (right side). In this example, a setpoint temperature (i.e., the temperature that the cooling device 160 is set to), a measured temperature of the support plate 170 (e.g., by temperature sensing means 120), and the CPA 131 volume added to the container 184, 284 of mixing device 180, 280 are illustrated. Mixing device 180, 280 is subject to cooling from a starting temperature to 0° C. over an approximate fifteen-minute time frame while an initial volume (2 ml) of CPA has been added. Once the mixing device 180, 280 is cooled to 0° C. a first volume of CPA is added to the container 184, 284. The setpoint temperature is held at 0° C. during this first addition. Once added, the basket 190, 290 is rotated according to the above-described methodologies. Subsequently, the cooling device is set to cool the mixing device 180, 280 down to approximately −65° C. over the course of approximately seventy minutes, while stepwise addition of CPA 131 is added. During this time the basket is continuously (or intermittently) rotated. As a result of this process, the biological sample 185 is vitrified with the CPA 131. At this point, the mixing device 180, 280 can be moved into long-term storage, such as a −140° C. freezer.

Another advantage of the present system is that because the sample is rotated within the CPA 131, thus ensuring proper mixing, higher concentrations of certain CPA components can be utilized. For example, it is known to use DMSO in low concentrations in a cryoprotectant. The DMSO aids in cell survival during the cooling process, but is also toxic to cells at higher concentrations, and especially at warmer temperatures. However, DMSO is less toxic to cells at lower temperatures, but also increases in viscosity as it is cooled, making it harder to mix. Prior art systems have struggled with the ability to vitrify biological samples and maintain high cell survivability because higher concentrations of DMSO are toxic at warmer temperatures, but also very hard to adequately mix at low temperatures. Traditional stirring devices do not provide adequate and homogenous mixing, and thus have only provided systems that create toxic conditions for cells. In contrast, the mixing device 180, 280 of the present invention rotates the biological sample 185 within the CPA (as opposed to mixing the CPA around the sample), which does not have the aforementioned drawbacks. Because the present systems and methods can adequately mix highly viscous liquids, higher concentrations of DMSO, or other permeating cryoprotectants, introduced at lower temperatures, can be achieved. This results in less cellular toxicity and greater cell viability upon thawing.

The CPA of the present invention, as mentioned above, has a higher concentration of permeating cryoprotectant, such as DMSO, compared to traditional CPAs. In embodiments of the present invention, in order to make the CPA, distilled water and the permeating cryoprotectant (e.g., DMSO) are mixed, with the permeating cryoprotectant accounting for approximately 50-75% of the initial volume. Additional components are then added, which include (i) at least one salt and (ii) at least one sugar. The salt, such as a sodium, potassium, or magnesium salt, has a concentration of approximately 1-5% by weight of the final CPA composition. The sugar has a concentration of approximately 5-20% by weight of the final CPA composition. In preferred embodiments, the CPA also includes trace amounts of an ice-formation inhibiting component. The CPA may also include at least one component configured to mitigate low temperature cellular damage, such as an enzyme inhibiting chemical.

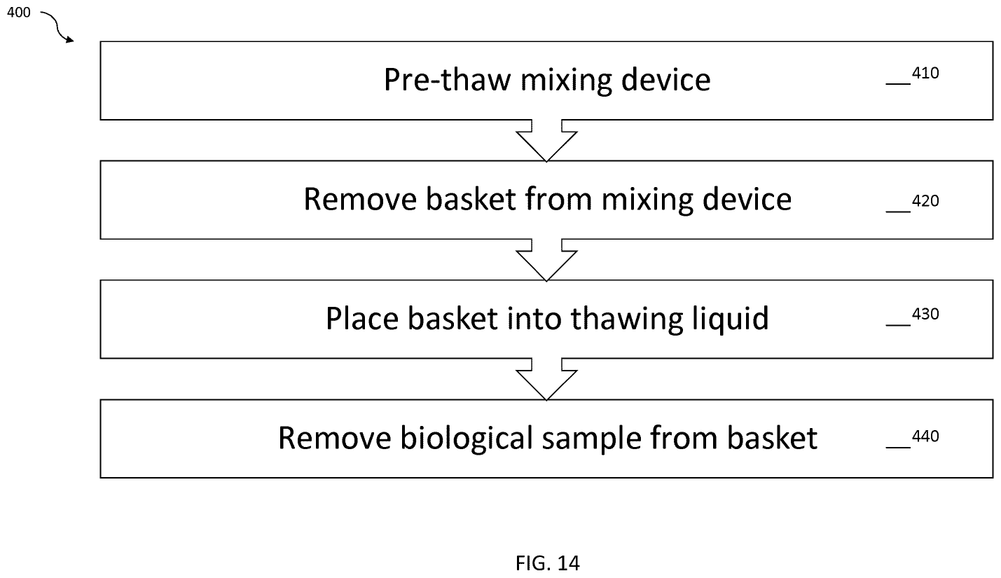

Referring to FIG. 14, and a third aspect of the invention, there is shown a block diagram illustrating a method 400 of warming at least one biological sample 185. As discussed above, the biological sample 185 and CPA 131 are vitrified through the cryopreservation process of method 300. Warming process 400 can be carried out to warm the biological sample, such that it can be subsequently used for a desired purpose (e.g., transplantation, cell extraction, analysis, etc.). Because the vitrified biological sample 185 and CPA 131 are fragile, a pre-warming step 410, is first carried out. This entails placing the mixing device 180, 280 into an environment that is warmer than the long-term storage environment. In one embodiment, step 410 includes placing the mixing device 180, 280 in a −100 to −80°° C. freezer for a sufficient amount of time (e.g., 10 minutes to three hours) to allow for the sample to become less brittle.

The basket 190,290 is then removed from the mixing device 180, 280 (e.g., by manual removal), corresponding to step 420, and placed into a vial 142 containing a warming liquid 143 (e.g., warmed culture media), corresponding to step 430. Once removed, and prior to placement in the vial 142, excess CPA 131 can be allowed to wash out. The basket 190, 290 is left within the warming liquid 143 for a period of time (e.g., 9 seconds to 3 minutes). As FIG. 11 illustrates, basket 190, 290 may be made from a material that floats in the thawing liquid 143. During this time it is desirable, although not explicitly necessary, to ensure that the basket 190, 290 is angled within the vial 142. By doing this CPA 131, as it warms, drains into the bottom of vial 142. Because the CPA is denser (and cooler) than the warming liquid and the basket 190, 290 has at least one gap in the side wall 199, 299 (along with retaining wall 194 being porous/pores 294) the CPA can separate from the biological sample 185 and out of the basket 190, 290 without user intervention (e.g., CPA removal is gravity assisted). It is noted that step 430 can be repeated one or more times in additional vials 142 to ensure that all CPA has been washed out. Thus, another advantage of the present invention is realized.

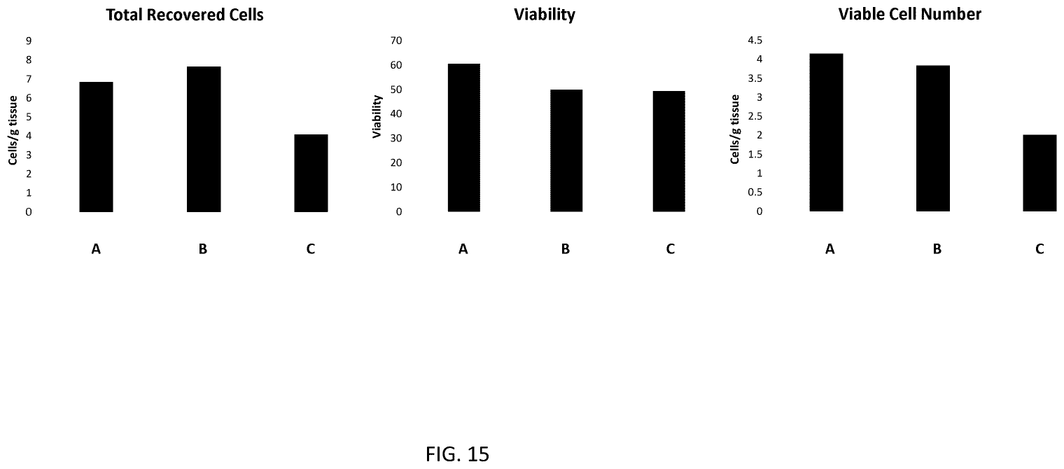

FIG. 15 illustrates post cryopreservation viability utilizing the above-described systems and methods (100, 200, 300) as compared to standard cryopreservation techniques (i.e., without vitrification), according to a first example. To assess post-warming conditions, three rat liver segments were subject to cryopreservation. After warming, each was digested and subject to cell count and viability analysis. Bar “A” in each of the three graphs corresponds to a rat liver that underwent vitrification with a cooling rate of 1° C./minute throughout the method 200. Bar “B” in each of the three graphs corresponds to a rat liver that underwent vitrification with a cooling rate of 2° C./minute until −30° C., and then 1° C./minute throughout the remainder of the method 200. Bar “C” in each of the three graphs corresponds to a control method, where a rat liver was cryopreserved using standard techniques at a cooling rate of 1° C./minute, but was not vitrified. All livers were subject to the same warming procedure. As is apparent from FIG. 15, the control (e.g., bar “C”) exhibited lower total recovered cells and viable cell number as compared to the method of the present invention. Cell viability was also higher for bar “A”, as compared to the control. Thus, FIG. 10 illustrates that more cells, with a greater cell viability post-thaw are realized through the use of the present systems and methods.

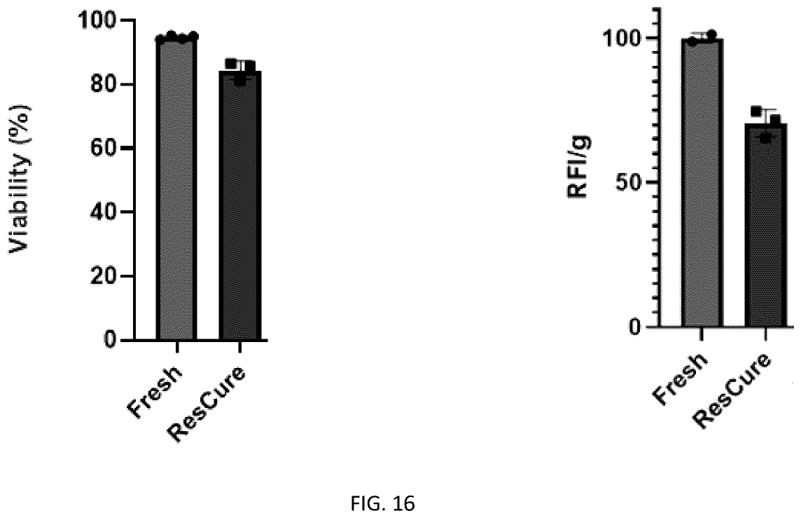

FIG. 16 illustrates post cryopreservation viability (left graph) and alamar blue florescence intensity (right graph) utilizing the above-described systems and methods (100, 200, 300), according to a second example. In this example, mouse kidney samples underwent a vitrification process utilizing the aforementioned system and method. Specifically, kidney samples were placed in cooling arraignment 150 and subject to method 300. With regard to steps 330, 340 cooling was at a rate of −1° C./min to −100° C. The samples were then placed into a −140° C. freezer for long term storage. Subsequently, the kidney samples underwent a warming procedure as described above. Specifically, the kidney samples were warmed to −80° C. in dry ice. Subsequently the baskets holding the kidney samples were placed within vials containing warming media and warmed for approximately two minutes. The warming media was replaced five times (i.e., the kidney samples were washing in warming media for a total of six times). Post warming, one of the kidney samples was digested and subject to cell count and viability analysis, and another sample was subject to alamar blue testing. As the left graph of FIG. 16 illustrates, cell viability of the first kidney sample post digestion was approximately 80% (ResCure) as compared to a control sample (i.e., digestion of a rat kidney sample that underwent no cooling/thawing (Fresh)). The right graph illustrates the results of an alamarBlue® Assay by ThermoFisher, which is designed to quantitatively measure cell proliferation. The second kidney sample was subject to the above-described systems and methods but was not digested. As the right graph of FIG. 16 illustrates, alamarBlue intensity of the second kidney sample post vitrification and subsequent warming was approximately 70% (ResCure) of a control sample that was not vitrified and warmed (i.e, (Fresh)). As these graphs illustrate, there was high cell viability and alamarBlue intensity, indicating that there was minimal cell death through the vitrification and warming process.

As the aforementioned description makes evident, the present system and methods provide numerous benefits over the prior art. By directly moving (e.g., rotating) a biological sample within a CPA, as opposed to prior art systems where the sample is static and a stirring device moves the CPA, improved mixing occurs between the sample and the liquid it is exposed to. Better mixing allows for higher concentration of permeating cryoprotectant (e.g., DMSO) without reaching cell toxicity, which greatly improves cell recovery and viability through the preservation and warming process. The system also is simpler to use, as there is no need for removal of substances, such as CPA, (i.e., no waste reservoir is required) and the basket and container are used for both cryopreservation and long-term storage (i.e., vitrification and storage occur in the same vessel). Additionally, by having a removable basket that contains the biological sample, the sample can be removed and thawed much more easily.

It is further noted that while the above description of the invention describes moving the biological sample by way of rotation, other modes of mixing are within the scope of the invention. For example, instead of rotating about the central axis of the container, the basket can rotate around the periphery of the container. Moreover, instead of rotation the basket in one direction, the basket can be rotated in one direction (e.g., clockwise) for a set period of time and then rotated in the opposite direction (e.g., counter-clockwise) for another set period of time, and repeated. Still further, the basket can be vibrated or otherwise reciprocated in a back-and-forth motion (vertically and/or laterally).

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

1. A system for the cryopreservation of at least one biological sample, comprising:
one or more mixing devices configured to hold the at least one biological sample and a cryoprotectant; and
a cooling device configured to cool the one or more mixing devices;
wherein the one or more mixing devices each further comprises a basket for receiving the at least one biological sample; and
wherein the basket is configured to move within the respective mixing device.

2. The system of claim 1,
wherein the basket comprises a drive shaft and/or arm connected to a sample receiving area to receive the at least one biological sample, and
wherein the drive shaft and/or arm is configured to rotate such that the sample receiving area and the at least one biological sample rotate within the mixing device.

3. The system of claim 2,
wherein the one or more mixing devices each comprise a container and a cap,
wherein the basket is located within the container and the drive shaft and/or arm extends from the sample receiving area to the cap, and
wherein the basket is removeable from the container.

4. The system of claim 2, further comprising:
a motor located external to the container, the motor configured to provide a force to the drive shaft or arm in order to cause the drive shaft or arm to rotate; and
a clutch coupled to the motor.

5. The system of claim 2, wherein the basket further comprises a retaining wall, the retaining wall being at least partially porous, or wherein a sidewall of the sample receiving area is at least partially porous.

6. The system of claim 5,
wherein the sample receiving area has a cylindrical shape, and
wherein the retaining wall extends across the sample receiving area, creating a sample compartment, the sample compartment being smaller in size than the sample receiving area.

7. The system of claim 6,
wherein the basket further comprises a filler,
wherein the filler is located on a first side of the retaining wall within the sample receiving area, and
wherein the at least one biological sample is configured to be located on a second side, opposite the first side, of the retaining wall corresponding to the sample compartment.

8. The system of claim 6:
wherein the arm comprises at least one arm, the at least one arm connecting the drive shaft to the sample receiving area; and
a porous lid configured to cover the sample receiving area.

9. The system of claim 1, further comprising:
a processing unit;
at least one pump;
a temperature sensing means;
a support plate, the one or more mixing devices configured to sit in the support plate; and
a cryoprotectant reservoir, containing the cryoprotectant connected, to the at least one pump;
wherein the temperature sensing means is configured to measure a temperature of the cooling device, the support plate and/or the one or more mixing devices,
wherein the processor is configured to receive an output from the temperature sensing means, and
wherein processing is configured to (i) control the cooling device to control a rate of cooling and (ii) control activation of the pump to control addition of the cryoprotectant to the one or more mixing devices based upon a sensed temperature, such that the biological sample is vitrified.

10. The system of claim 9, wherein the cooling device is configured to cool the biological sample at a rate of between 0.2-5° C./min, wherein the basket is configured to rotate at a rate of between 5 and 120 rpm, and wherein cryoprotectant is added in a stepwise manner, such that addition occurs every time the cooling device, the support plate and/or the one or more mixing devices is cooled by between 1-5° C., more preferable, between 1-2° C.

11. A method for the cryopreservation of a biological sample, the method comprising:
a) placing a biological sample within a basket located in a container;
b) placing the container within a support plate;
c) adding a cryoprotectant to the container such that the biological sample is exposed to the cryoprotectant;
d) cooling the container during step c) with a controlled rate freezer; and
e) moving the basket within the container during the cooling in order to mix the cryoprotectant.

12. The method of claim 11, wherein step e) comprising rotating the basket within the container.

13. The method of claim 11, wherein the cooling is at a rate of about 0.1 to 5.0 C/min.

14. The method of claim 12, wherein the basket is rotated at a rate of about 5-120 rpm.

15. The method of claim 11, wherein a temperature sensing means measures a temperature of the container, the support plate, or the controlled rate freezer, and an amount of the cryoprotectant added is controlled based on the measured temperature.

16. The method of claim 15, wherein a rate at which the cryoprotectant is added is controlled based on the measured temperature and a phase diagram of the cryoprotectant, and wherein cryoprotectant is added in a stepwise manner, such that addition occurs every time the container is cooled by between 1-5° C., more preferable, between 1-2° C.

17. The method of claim 11, wherein the cryoprotectant is not removed from the container during the cryopreservation.

18. The method of claim 11, wherein as a result of the method, the biological sample is vitrified.

19. A method of warming a cryopreserved biological sample that has undergone cryopreservation of claim 11, comprising:
removing the basket from the container; and
placing the basket, containing the biological sample and cryoprotectant, within a warming solution.

20. The method of claim 19, wherein as the biological sample and cryoprotectant warm, the cryoprotectant separates from the basket and the biological sample.
